(19) United States
(12) Patent Application Publication
(10) Pub. No.: US 2010/0023935 A1
(43) Pub. Date: Jan. 28, 2010

(54) APPARATUS, SYSTEM AND METHOD FOR SOFTWARE UPGRADE

(75) Inventors: Jong-Ho Lee, Seoul (KR); Kwang-Hyun Koh, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/374,708

(22) PCT Filed: Jul. 24, 2007
(86) PCT No.: PCT/KR2007/003553

§ 371 Date: Jan. 22, 2009

(30) Foreign Application Priority Data
Jul. 24, 2006 (KR) 10-2006-0069359

(51) Int. Cl. G06F 9/44

(52) U.S. Cl. 717/168

(57) ABSTRACT

An apparatus, system and method for software upgrade are provided. The software upgrading system includes a broadcast transmitting device which transmits a digital broadcasting signal; a broadcast receiving device which receives the digital broadcasting signal, extracts upgrade information that relates to acquiring an upgrade image for upgrading software from the digital broadcasting signal which is received, and requests the upgrade image based on the upgrade information which is extracted; and an upgrade image storage device which transmits the upgrade image according to the upgrade image request. The broadcast receiving device upgrades the software by receiving the upgrade image from the upgrade image storage device.

### CROSS-REFERENCE TO RELATED APPLICATIONS

This application is a National Stage of International Application No. PCT/KR2007/003553 filed Jul. 24, 2007 and claims benefit of Korean Application No. 10-2006-0069359 filed on Jul. 24, 2006, the disclosure of which is incorporated herein in its entirety by reference.

### BACKGROUND OF THE INVENTION

1. Field of the Invention

Apparatuses, systems and methods consistent with the present invention relate to software upgrading, and more particularly, to software upgrading that can upgrade software built in a broadcast receiving apparatus for a digital broadcasting signal.

2. Description of the Related Art

Recently, as digital broadcasting is becoming more widespread, software for a broadcast receiving apparatus is becoming complicated and the necessity for upgrading the software is on the increase.

Accordingly, standards for providing software upgrade service in the digital broadcasting are being developed. As a representative example, a software download data service has been prescribed in the A/97 standard established by the Advanced Television Systems Committee (ATSC), and according to this guideline, software can be upgraded.

However, since software developers and broadcast receiving apparatus developers are becoming more diverse, and particularly in the A/97 standard, upgrade images are directly transmitted by a data carousel, and it is difficult to carry many upgrade images on the digital broadcasting signal at the same time in order to simultaneously proceed with the software upgrade of many broadcast receiving apparatuses in a limited bandwidth.

Accordingly, there is a need for an apparatus, system and method for transmitting the upgrade images to the broadcast receiving apparatus more efficiently.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus, system and method for software upgrade, which can upgrade software through an upgrade image received by broadcast receiving apparatus by using position information in which the upgrade image exists.

According to an aspect of the present invention, there is provided a software upgrading apparatus including an upgrade information extraction module which extracts upgrade information that relates to acquiring an upgrade image for upgrading software from a digital broadcasting signal, an upgrade image request module which requests the upgrade image on the basis of the upgrade information which is extracted, and an upgrade execution module which upgrades the software by using the upgrade image received according to the request.

According to another aspect of the present invention, there is provided a software upgrading system including a broadcast transmitting device which transmits a digital broadcasting signal, a broadcast receiving device which receives the digital broadcasting signal, extracts upgrade information that makes it possible to acquire an upgrade image for upgrading software from the digital broadcasting signal which is received, and requests the upgrade image on the basis of the upgrade information which is extracted, and an upgrade image storage device which transmits the upgrade image according to the upgrade image request, wherein the broadcast receiving device upgrades the software by receiving the upgrade image from the upgrade image storage device.

According to still another aspect of the present invention, there is provided a software upgrading method including receiving a digital broadcasting signal, extracting upgrade information for upgrading software from the digital broadcasting signal which is received, requesting an upgrade image for upgrading the software on the basis of the upgrade information which is extracted, and upgrading the software by receiving the upgrade image.

### BRIEF DESCRIPTION OF THE DRAWINGS

The above and other aspects of the present invention will be more apparent from the following detailed description of exemplary embodiments taken in conjunction with the accompanying drawings, in which:

FIG. 1 is a view illustrating a system for software upgrade according to an exemplary embodiment of the present invention;

FIG. 2 is a block diagram illustrating the construction of a broadcast receiving apparatus according to an exemplary embodiment of the present invention;

FIG. 3 is a flowchart illustrating a software upgrading method according to an exemplary embodiment of the present invention;

FIG. 4 is a view illustrating the structure of a data carousel according to an exemplary embodiment of the present invention;

FIG. 5 is a view illustrating the structure of Group Information Indication (GII) information according to an exemplary embodiment of the present invention;

FIG. 6 is a view illustrating the structure of a groupCompatibility( ) descriptor included in the GII information according to an exemplary embodiment of the present invention;

FIG. 7 is a view illustrating the structure of a subDescriptor of the groupCompatibility( ) descriptor according to an exemplary embodiment of the present invention; and

FIG. 8 is a view illustrating the structure of a GII moduleInfoDescriptor according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. The aspects and features of the present invention and methods for achieving the aspects and features will be apparent by referring to the exemplary embodiments to be described in detail with reference to the accompanying drawings. However, the present invention is not limited to the exemplary embodiments disclosed hereinafter, but can be implemented in diverse forms. The matters defined in the description, such as the detailed construction and elements, are provided to assist those of ordinary skill in the art in gaining a understanding of the invention, and the present invention is only defined within the scope of the appended claims. In the entire description of the present invention, the same drawing reference numerals are used for the same elements across various figures.

The present invention will be described herein with reference to the accompanying drawings illustrating block diagrams and flowcharts for explaining an apparatus, system and method for software upgrade according to exemplary embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

Also, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

In the following description of the present invention, the term “software” relates to software provided in a broadcast receiving apparatus that receives a digital broadcasting signal, and the term “upgrade image” relates to information for upgrading the software.

Also, unless otherwise described, terms used in the following description of the present invention will follow A/97 standards established by ATSC.

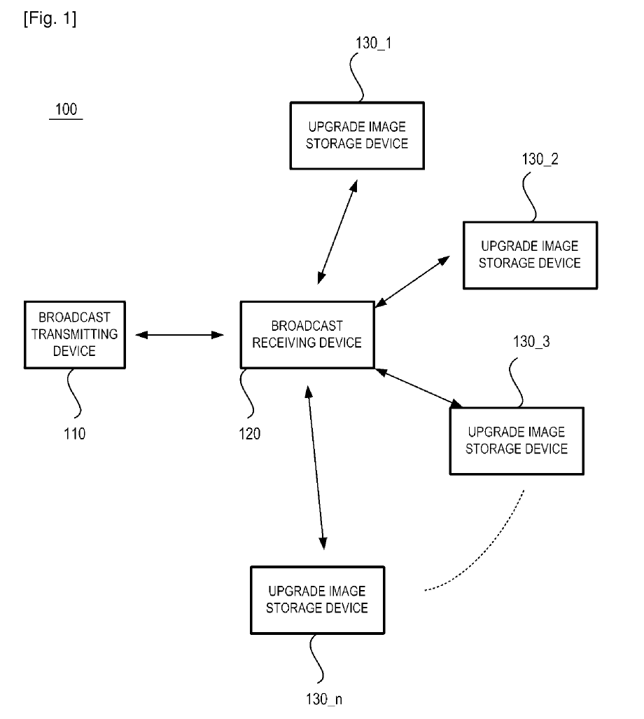

FIG. 1 is a view illustrating a system for software upgrade according to an exemplary embodiment of the present invention.

Referring to FIG. 1, the software upgrading system 100 according to an exemplary embodiment of the present invention includes a broadcast transmitting device 110, a broadcast receiving device 120, and a plurality of upgrade image storage devices 130_1, 130_2, 130_3, . . . , 130_{—}n.

If the broadcast transmitting device 110 transmits a digital broadcasting signal, the broadcast receiving device 120 receives the digital broadcasting signal, and extracts upgrade information that makes it possible to acquire an upgrade image for software upgrade from the received digital broadcasting signal. In this case, the upgrade information includes position information of the upgrade image existing on a network and upgrade image identification information for identifying the upgrade image, and may be expressed in the form of a Uniform Resource Locator (URL).

The broadcast receiving device 120 receives the corresponding upgrade images from the upgrade image storage devices 130_1, 130_2, 130_3, . . . 130_{—}n using the extracted upgrade information, and upgrades software.

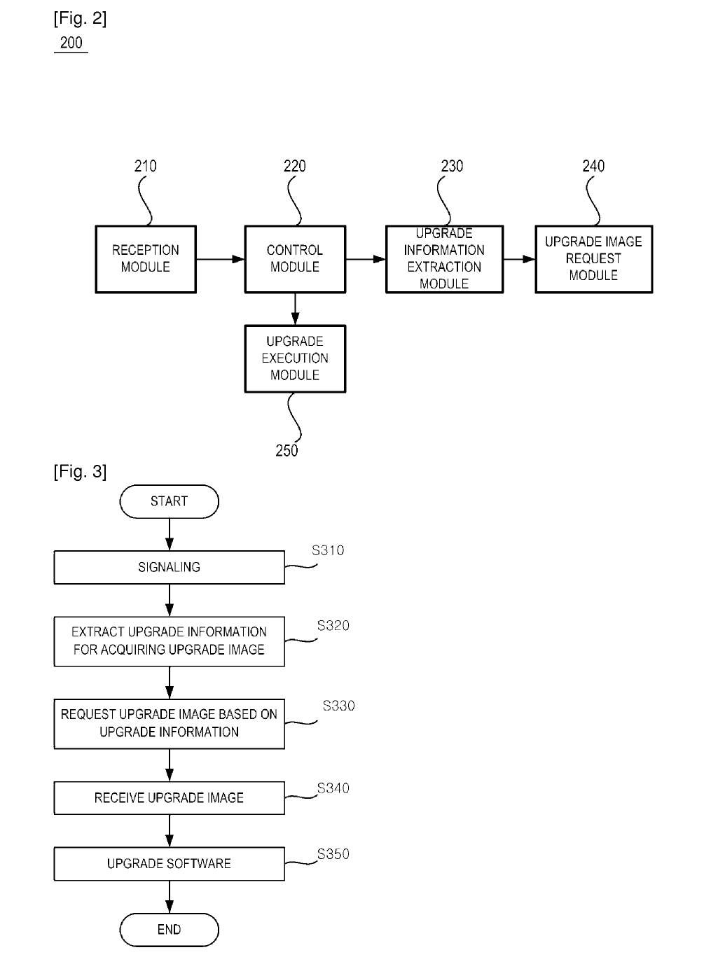

FIG. 2 is a block diagram illustrating the construction of a broadcast receiving apparatus according to an exemplary embodiment of the present invention.

Referring to FIG. 2, the broadcast receiving apparatus 200 according to an exemplary embodiment of the present invention includes a reception module 210, a control module 220, an upgrade information extraction module 230, an upgrade image request module 240, and an upgrade execution module 250. This broadcast receiving apparatus 200 of FIG. 2 corresponds to the broadcast receiving apparatus 120 of FIG. 1.

The reception module 210 receives a digital broadcasting signal including upgrade information for software upgrade, or an upgrade image.

The control module 220 operates to extract the upgrade information for acquiring the upgrade image according to the information received by the reception module 210, or to perform the upgrade.

The upgrade information extraction module 230 extracts the upgrade information for acquiring the upgrade image from the received digital broadcasting signal, and the upgrade image request module 240 requests the upgrade image through a network on the basis of the extracted upgrade information.

The upgrade execution module 250 upgrades the software built in the broadcast receiving apparatus 200 by using the received upgrade image.

In the exemplary embodiment of the present invention, the term “module”, as used herein, relates to, but is not limited to, a software or hardware component, such as a Field Programmable Gate Array (FPGA) or Application Specific Integrated Circuit (ASIC), which performs certain tasks. A module may be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented so as to be executed one or more CPUs in a device or a security multimedia card.

Hereinafter, the operation of the modules as illustrated in FIG. 2 will be described in more detail with reference to a flowchart as illustrated in FIG. 3.

First, the broadcast receiving apparatus 200 discriminates whether the received digital broadcasting signal provides software upgrade function by signaling of the digital broadcasting signal (S310).

That is, if the reception module 210 receives the digital broadcasting signal, the control module 220 tunes a channel including an upgrade image providing service from the received digital broadcasting signal through a user's channel selection or a channel selection performed by the broadcast receiving apparatus 200 itself. In this case, the control module 220 confirms that the software upgrade service is included in a virtual channel by checking a virtual channel table that exists in the received digital broadcasting signal.

For example, if a service type having a specified value exists in the virtual channel included in the virtual channel table, it can be determined that the software upgrade service according to the present invention is provided through the channel.

Then, the control module 220 acquires a Program Map Table (PMT) of the virtual channel that provides the software upgrade service. The control module 220 obtains a Program Identification (PID) of a data carousel, through which the upgrade information for the software upgrade is transmitted, from the acquired PMT, and obtains a Download Server Initiate (DSI) table of the data carousel by using the PID.

FIG. 4 is a view illustrating the structure of a data carousel according to an exemplary embodiment of the present invention. Although the basic structure as illustrated in FIG. 4 is similar to the data carousel structure in the A/97 standard of ATSC, the difference between them can be clearly understood through the following description.

The upgrade information extraction module 230 extracts the upgrade information by using the data carousel as shown in FIG. 4.

More specifically, in the first exemplary embodiment of the present invention, the upgrade information extraction module 230 extracts the GII (Group Information Indication) information that exists in the DSI table, and uses the subDescriptor structure of a groupCompatibility( ) descriptor included in the GII information.

The upgrade information extraction module 230 confirms the manufacturer of the broadcast receiving apparatus through information about “descriptorType”, “specifierType”, and “specifierData” of the groupCompatibility( ) descriptor, and if the confirmed manufacturer is different from the manufacturer of the present broadcast receiving apparatus, it judges that the software upgrade is for the broadcast receiving apparatus of another manufacturer. Then, the upgrade information extraction module 230 judges whether the model of the groupCompatibility( ) descriptor is identical with the model of the present broadcast receiving apparatus by confirming the “model” value of the groupCompatibility( ) descriptor. If the models are identical with each other, the upgrade information extraction module 230 judges whether the version of the groupCompatibility( ) descriptor is identical with the software version of the present broadcast receiving apparatus by confirming the “version” value of the groupCompatibility( ) descriptor. If the versions are identical with each other, it is not necessary to upgrade the software, and thus the upgrade information extraction module 230 does not proceed with its operation any further. On the other hand, if the versions are different from each other, the upgrade information extraction module 230 refers to the “subDescriptor” structure of the groupCompatibility( ) descriptor.

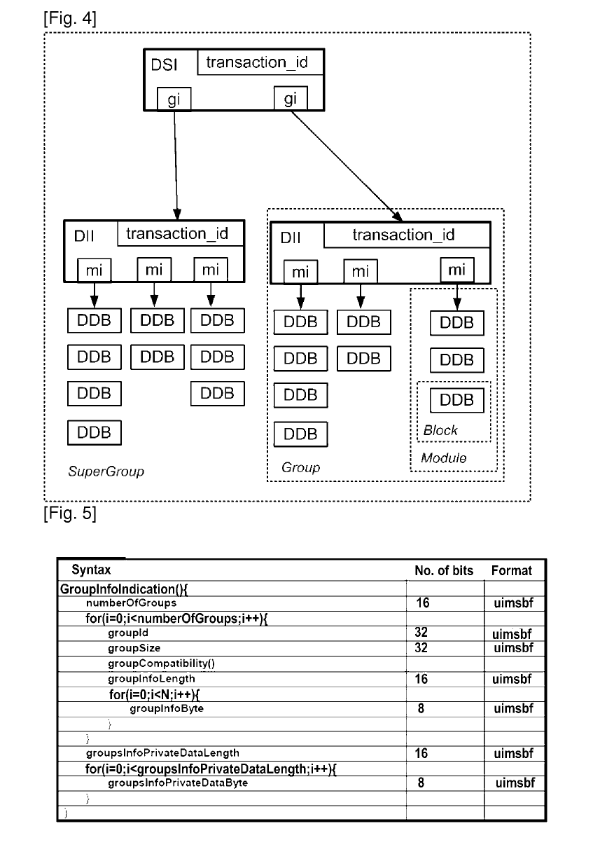

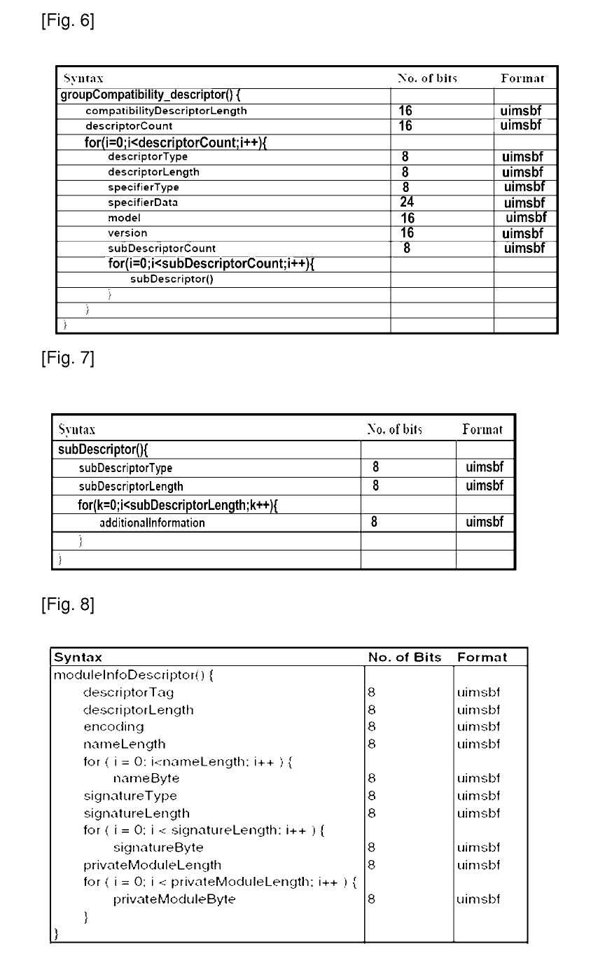

The structure of the GII information, the structure of the groupCompatibility( ) descriptor, and the structure of the subDescriptor are illustrated in FIGS. 5, 6 and 7, respectively. The structures as illustrated in FIGS. 5 to 7 follow the A/97 structure of ATSC. Referring to FIG. 7, in the “additionalInformation” of the subDescriptor, in which certain information on the software manufacturer may be recorded, upgrade information such as a URL storing the upgrade image, an IPv4/v6 address, the position of the upgrade image, and so forth, is recorded. The upgrade information extraction module 230 can obtain the upgrade information by extracting the “additionalInformation” information.

In the second exemplary embodiment of the present invention, the upgrade information is recorded in the “privateModuleByte” of the Download Information Indication (DII) moduleInfoDescriptor structure, not in the subDescriptor. In the moduleInfoDescriptor, files to be downloaded are described in detail. In the present invention, the upgrade information to obtain the upgrade image is described in the “privateModuleByte” that contains additional information, and thus the upgrade information extraction module 230 can obtain the upgrade information from the received digital broadcasting signal. In FIG. 8, the DII moduleInfoDescriptor structure is illustrated.

According to the A/97 standard of ATSC, information on files for upgrading the software is acquired through the DII, and the corresponding files are provided to the broadcast receiving apparatus through the data carousel. In this case, the broadcast receiving apparatus upgrades the software by directly receiving the files required for the software upgrade through a broadcasting system, and the files include the upgrade image. In the third exemplary embodiment of the present invention, however, the upgrade image is not directly included in the file, but the file recorded with upgrade information that is required for the software upgrade is transferred to the broadcast receiving apparatus. In other words, according to the present invention, the upgrade information extraction module 230 extracts the upgrade information by analyzing the file. In this case, the file may be in diverse forms including an XML or binary file. The term “file” in the third exemplary embodiment of the present invention may be understood as a concept corresponding to the “module” as illustrated in FIG. 4.

Referring to FIG. 3, if the upgrade information is extracted by the upgrade information extraction module 230 in accordance with the methods as in the first to third exemplary embodiments of the present invention (S320), the upgrade image request module 240 requests the upgrade image through a network on the basis of the extracted upgrade information (S330). In this case, a plurality of servers for storing the upgrade images are connected on the network, and the upgrade image request module 240 connects to a server that corresponds to the extracted upgrade information, and requests the upgrade image to the connected server. Examples of the servers include the upgrade image storage devices 130_1, 130_2, 130_3, . . . , 130_{—}n, illustrated in FIG. 1.

If the corresponding upgrade image is transmitted in response to the request, the reception module 210 receives the transmitted upgrade image (S340). In this case, the control module 220 controls the upgrade execution module 250 to upgrade the corresponding software using the received upgrade image (S350).

As described above, according to the present invention, the broadcast receiving apparatus can upgrade the software by receiving the upgrade image more efficiently.

In addition, many upgrade images required by the broadcast receiving apparatus are not directly transmitted through the broadcasting signal, but only information about the upgrade image is transmitted, so that the upgrade image for the software upgrade can be efficiently transferred to the broadcast receiving apparatus even through the limited bandwidth of the digital broadcasting signal.

Although exemplary embodiments of the present invention have been described for illustrative purposes, those skilled in the art will appreciate that various modifications, additions and substitutions are possible, without departing from the scope and spirit of the invention as disclosed in the accompanying claims.

1. A broadcast receiving apparatus for software upgrade, the apparatus comprising: an upgrade information extraction module which extracts position information that relates to acquiring an upgrade image for upgrading software from a digital broadcasting signal;
an upgrade image request module which requests the upgrade image based on the position information which is extracted; and
an upgrade execution module which upgrades the software by using the upgrade image received according to the request.

2. The broadcast receiving apparatus of claim 1, wherein the position information comprises position information on a network in which the upgrade image exists.

3. The broadcast receiving apparatus of claim 1, wherein the upgrade information extraction module extracts the position information from subDescriptor information of a groupCompatibility( ) descriptor included in Group Information Indication information constituting a data carousel of the digital broadcasting signal.

4. The broadcast receiving apparatus of claim 1, wherein the upgrade information extraction module extracts the position information from “privateModuleByte” information of a Download Information Indication moduleInfoDescriptor structure constituting a data carousel of the digital broadcasting signal.

5. The broadcast receiving apparatus of claim 1, wherein the upgrade information extraction module constructs a data carousel of the digital broadcasting signal, and extracts the position information from files containing information required for the software upgrade.

6. A software upgrading system comprising:
a broadcast transmitting device which transmits a digital broadcasting signal;
a broadcast receiving device which receives the digital broadcasting signal, extracts position information that relates to acquiring an upgrade image for upgrading software from the digital broadcasting signal which is received, and requests the upgrade image based on the position information which is extracted; and
an upgrade image storage device which transmits the upgrade image according to the upgrade image request,
wherein the broadcast receiving device upgrades the software by receiving the upgrade image from the upgrade image storage device.

7. The software upgrading system of claim 6, wherein the position information comprises position information on a network in which the upgrade image exists.

8. The software upgrading system of claim 6, wherein the broadcast receiving device extracts the position information from subDescriptor information of a groupCompatibility( ) descriptor included in Group Information Indication information constituting a data carousel of the digital broadcasting signal which is received.

9. The software upgrading system of claim 6, wherein the broadcast receiving device extracts the position information from “privateModuleByte” information of a Download Information Indication moduleInfoDescriptor structure constituting a data carousel of the digital broadcasting signal which is received.

10. The software upgrading system of claim 6, wherein the broadcast receiving device constructs a data carousel of the digital broadcasting signal which is received, and extracts the position information from files containing information required for the software upgrade.

11. A software upgrading method comprising:
receiving a digital broadcasting signal;
extracting position information for upgrading software from the digital broadcasting signal which is received;
requesting an upgrade image for upgrading the software based on the position information which is extracted; and
upgrading the software by receiving the upgrade image.

12. The software upgrading method of claim 11, wherein the position information comprises position information on a network in which the upgrade image exists.

13. The software upgrading method of claim 11, wherein the extracting the position information comprises extracting the position information from subDescriptor information of a groupCompatibility( ) descriptor included in Group Information Indication information constituting a data carousel of the digital broadcasting signal which is received.

14. The software upgrading method of claim 11, wherein the extracting the position information comprises extracting the position information from “privateModuleByte” information of a Download Information Indication moduleInfoDescriptor structure constituting a data carousel of the digital broadcasting signal which is received.

15. The software upgrading method of claim 11, wherein the extracting the position information comprises constructing a data carousel of the digital broadcasting signal which is received, and extracting the position information from files containing information required for the software upgrade.
